(19) United States
(12) Patent Application Publication
(10) Pub. No.: US 2012/0099191 A1
(43) Pub. Date: Apr. 26, 2012

(54) PERISCOPE DEVICE

(75) Inventors: Anders Mannelqvist, Domsjo (SE); Daniel Nordin, Omskoldvik (SE); Torbjöm Gustafsson, Linkoping (SE); Per Carleburg, Stockholm (SE)

(73) Assignee: BAE Systems Hagglunds Aktiebolag, Ornskoldsvik (SE)

(21) Appl. No.: 13/266,963

(22) PCT Filed: Apr. 22, 2010
(86) PCT No.: PCT/SE2010/050444

§ 371 Date: Jan. 3, 2012

(30) Foreign Application Priority Data
May 7, 2009 (SE) 09503194

(51) Int. Cl. G02B 23/08

(52) U.S. Cl. 359/402

(57) ABSTRACT

The invention relates to a periscope device for transmission of a surrounding represented by first light borne information (L1) to the view opening (106), wherein the first light borne information (L1) at the view opening is arranged to be presented together with visual supplementary information represented by second light borne information (L2), wherein the visual supplementary information (L2) is arranged to be provided by means of a projector (P). The invention also relates to a vessel.

### TECHNICAL FIELD

The present invention relates to a periscope device according to the preamble in claim 1. The present invention also relates to a vessel.

### BACKGROUND

In order for drivers or other operators on e.g. military vehicles not having to expose themselves for possible threats but at the same time be able to see the surrounding they are equipped with periscopes. A problem is that driver or other operator wishes to be able to see e.g. vehicle information and then needs to turn to a computer screen or the corresponding such that the eye needs to be turned away from the surrounding seen through the periscope. A solution to this problem is to superpose information from a display element in the optical direct view such that the driver or other operator sees a combined image of the surrounding and desired information from the display in the window of the periscope. LED, OLED and LCD are examples on displays used.

A problem with such solutions is that the strength of light provided is insufficient which results in difficulties for driver/operator to see the superposed information.

### OBJECTS OF THE INVENTION

An object of the present invention is to provide a periscope device by means of which visual information may be superposed on the surrounding in the window of the periscope, which is simple, cost efficient and facilitates good representation of the image even in strong light conditions.

### SUMMARY OF THE INVENTION

These and other objects, apparent from the following description, are achieved by means of a periscope device and a vessel, which are of the type stated by way of introduction and which in addition exhibits the features recited in the characterising clause of the appended claims 1, 17. Preferred embodiments of the inventive periscope device are defined in appended dependent claims 2-16.

According to the invention the objects are achieved by a periscope device for transmission of a surrounding represented by first light borne information to the view opening, wherein the first light borne information at the view opening is arranged to be presented together with visual supplementary information represented by second light borne information, wherein the visual supplementary information is arranged to be provided by means of a projector.

By using a projector for projection of supplementary information a light intensive image source which facilitates use in normal to intense light conditions is obtained. The presented, e.g. superposed, supplementary information/image may thus be made brighter. The luminous intensity may further be controlled by means of the projector. Further, a projector facilitates easy modification of image size and image form, in order to compensate for distortion of optics, and placement of an image in the view opening. A projector facilitates easy construction in that no complicated optics is required. A projector is cost efficient. By projecting by means of a projector for providing the presented, e.g. superposed, image the presented/superposed image is not dependent upon the position of the head of the operator looking through the view opening.

According to an embodiment of the periscope device the first light borne information at the view opening is arranged to at least partly be superposed with the second light borne information representing the visual supplementary information. The advantage with superposition/partly superposition is that the operator has both information of the surrounding and supplementary information in the line of view.

According to an embodiment of the periscope device the visual supplementary information at the view opening represented by the second light borne information is arranged to be presented separated from the first light borne information. The advantage with separated supplementary information is e.g. when the supplementary information is of such a kind that it shall be available but not all the time in the line of view. The operator may then lock in the view opening where the surrounding is not shown but only the supplementary information.

According to an embodiment of the periscope device said presentation of the first and second light borne information is arranged to be provided by means of a beam splitter, arranged to reflectively redirect one of the first and second light borne information, and transmittingly redirect another of the first and second light borne information. Hereby easy presentation, e.g. superposition, is facilitated.

According to an embodiment the periscope device comprises a projection surface towards which the projector is arranged to project the second light borne information representing the visual supplementary information which is created in the shape of an image on the projection surface, wherein the projection surface is arranged to redirect the visual supplementary information for said presentation. Thus presentation, e.g. superposition, of supplementary information is facilitated such that the operator may see it through the view opening.

According to an embodiment of the periscope device the projection surface is arranged to diffusively reflectively redirect the second light borne information representing the visual supplementary information. Hereby a variant for presentation, e.g. superposition, of supplementary information in the form of the projected image is facilitated.

According to an embodiment of the periscope device the projection surface is through back projection arranged to diffusively transmittingly redirect the second light borne information representing the visual supplementary information.

According to an embodiment the periscope device comprises a light proof periscope body with an upper portion intended to be arranged externally to a vessel, and a lower portion intended to be arranged inside the vessel, wherein the first light borne information is arranged to be transmitted via an opening in the upper portion to the view opening arranged in the lower portion.

According to an embodiment the periscope device comprises a first redirecting surface arranged in the upper portion of the periscope body and a second redirecting surface arranged in the lower portion of the periscope body, wherein the first redirecting surface is arranged to redirect the first light borne information in a direction towards the second redirecting surface, wherein the second redirecting surface is arranged to redirect the first light borne information redirected from the first redirecting surface to the view opening. Hereby easy transmission of the first light borne information is facilitated.

According to an embodiment of the periscope device said projector is arranged in connection to the lower portion of the periscope body. Hereby the projector is arranged inside the vessel when the periscope device is arranged on a vessel and is thus protected by the vessel.

According to an embodiment of the periscope device the beam splitter is constituted by the second redirecting surface. Hereby a simpler device is obtained wherein fewer redirecting surfaces, i.e. fewer mirroring elements, are required for provision of said presentation, e.g. superposition, of the first light borne information representing surrounding and second light borne information representing visual supplementary information. Hereby the second light borne information is introduced into the periscope body of the periscope device, which results in a simpler construction which may be made more compact.

According to an embodiment of the periscope device said projector is arranged in connection to the upper portion of the periscope body. Hereby the projector is arranged outside the vessel when the periscope device is arranged on a vessel which may be advantageous if there is lack of space inside the vessel. Such a solution may be made compact and need not be adapted to surrounding space.

According to an embodiment of the periscope device the beam splitter is constituted by the first redirecting surface. Hereby a simpler device is obtained wherein fewer redirecting surfaces, i.e. fewer mirroring elements, are required for provision of said presentation, e.g. superposition, of first light borne information and second light borne information. Hereby the second light borne information is introduced into the periscope body of the periscope device, which results in a simpler construction which may be made more compact.

According to an embodiment of the periscope device the first redirecting surface and the second redirecting surface is constituted by the surface of a mirroring element. This is a conventional formation of a periscope, wherein projector, beam splitter and possible other redirecting surfaces may be arranged on a conventional/existing periscope. This thus facilitates easy upgrade of an existing periscope for provision of said presentation, e.g. superposition, of first light borne information representing surrounding and second light borne information representing visual supplementary information by means of projector, which may reduce costs for arrangement on a vessel of a periscope device according to the invention.

According to an embodiment of the periscope device the beam splitter is arranged relative to the first and second redirecting surface, wherein a redirecting surface is arranged to redirect the second light borne information redirected from the projection surface towards the beam splitter. This is a variant for upgrading of an existing periscope for provision of said presentation, e.g. superposition, of first light borne information representing surrounding and second light borne information representing visual supplementary information by means of a projector.

According to an embodiment the periscope device comprises a lens element arranged to modify the second light borne information prior to said presentation. This facilitates formation such that the focal plane where the operator sees the visual supplementary information/virtual image may lie closer or further away.

### DESCRIPTION OF THE DRAWINGS

A better understanding of the present invention will be had upon the reference to the following detailed description when read in conjunction with the accompanying drawings, wherein like reference characters refer to like parts throughout the several views, and in which:

FIG. 1 schematically illustrates a side view of a periscope device according to a first embodiment of the present invention;

FIG. 2 schematically illustrates a side view of a periscope device according to a second embodiment of the present invention;

FIG. 3 schematically illustrates a side view of a periscope device according to a third embodiment of the present invention;

FIG. 4 schematically illustrates a side view of a periscope device according to a fourth embodiment of the present invention;

FIG. 5 schematically illustrates a side view of a periscope device according to a fifth embodiment of the present invention; and

FIG. 6 schematically illustrates a vessel with a periscope device according to the present invention.

### DETAILED DESCRIPTION OF THE INVENTION

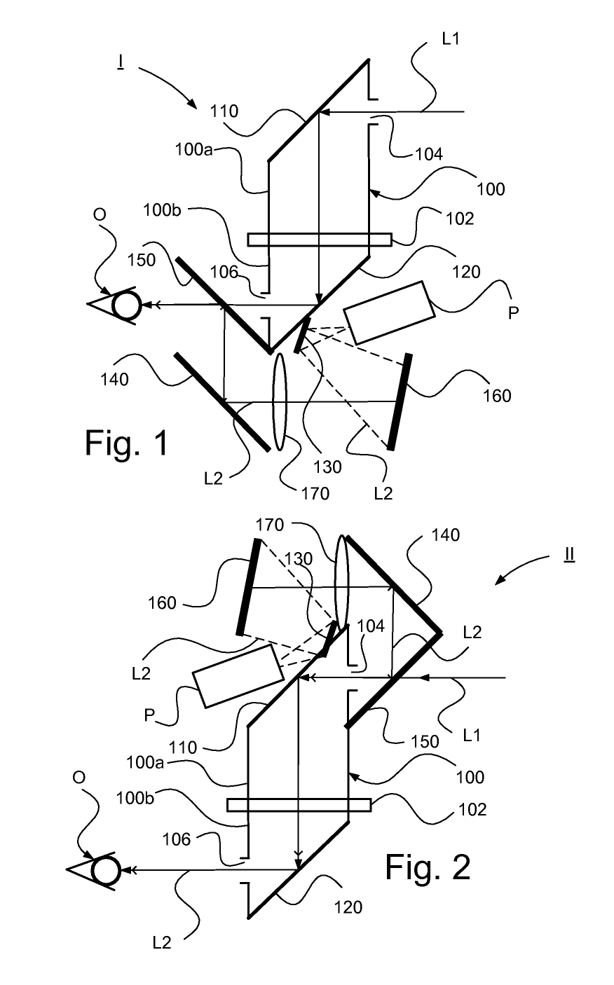

FIGS. 1-5 schematically illustrate a periscope device according to embodiments of the present invention.

The periscope I; II; III; IV; V according to the embodiments above comprises a light proof periscope body 100 through which surrounding light from the surrounding outside of the periscope device forming a first light borne information L1 is arranged to be transmitted such that an operator may see the surrounding represented by the surrounding light at another position, e.g. at another level than the level of the surrounding light, i.e. the first light borne information L1, will enter into the periscope body 100.

The periscope body 100 has an upper portion 100a intended to be arranged in an outer area, i.e. externally of a vessel such as a vehicle, and a lower portion 100b intended to be arranged in an internal area, i.e. inside the vessel such as a vehicle. Hereby a fastener 102 for fastening of the periscope device on a vessel is arranged in connection to the periscope body 100 such that the upper portion 100a projects externally and preferably above the vessel body and the lower portion 100b is present inside the vehicle such that it is accessible for an operator.

The periscope body 100 has an inlet opening 104 arranged in the upper portion 100a for receiving the first light borne information L1 representing the surrounding and an outlet opening 106 arranged in the lower portion whereby an operator O may see a representation of the surrounding.

The periscope device comprises a first redirecting surface 110; 410 arranged in the upper portion 100a of the periscope body 100 and a second redirecting surface 120; 320; 520 arranged in the lower portion 100b of the periscope body 100. According to an embodiment the first and/or second redirecting surface 110, 120 constitute the surface of a mirroring element, where the mirroring element may constitute a mirror element or a prism element. According to an embodiment the first and/or second redirecting surface 110, 120 constitute the surface of a mirror element. According to an embodiment the first and/or second redirecting surface 110, 120 constitute the surface of a prism element. According to an embodiment one of the first and second redirecting surface 110, 120 constitutes the surface of a mirror element and another of the first and second redirecting surface 110, 120 the surface of a prism element.

According to an embodiment the first redirecting surface 410 constitutes a beam splitter 410. According to an embodiment the second redirecting surface 320; 520 constitutes the surface of a beam splitter 320; 520. According to a variant the first redirecting surface 110; 410 constitutes at least a part of the internal surface of the upper portion 100a of the periscope body 100. According to a variant the second redirecting surface 120; 320; 520 constitutes at least a part of the internal surface of the lower portion 100b of the periscope body 100.

The first redirecting surface 110; 410 is arranged to redirect the first light borne information L1, i.e. the light borne information L1 incoming from the surrounding representing the surrounding, in the direction towards the second redirecting surface 120; 320; 520. The second redirecting surface 120; 320; 520 is arranged to redirect the first light borne information L1 redirected from the first redirecting surface 110 towards the outlet opening 106 or the view opening 106, i.e. in the direction towards the eye of the operator O when the operator looks in through the view opening.

According to an embodiment the first and second redirecting surfaces 110; 410, 120; 320; 520 are arranged to redirect the light borne information L1 by 90 degrees respectively. Hereby the first redirecting surface 110, 410 is angled by 45 degrees relative to incoming light borne information L1 and the second redirecting surface 120 is angled by 45 degrees relative to the redirected first light borne information L1 redirected by means of the first redirecting surface 110; 410. According to a variant the first redirecting surface 110; 410 and the second redirecting surface 120; 320; 520 are arranged in parallel relative to each other.

The periscope device I; II; III; IV; V according to the embodiments in FIGS. 1-5 further comprises a projector P arranged to project visual supplementary information in the form of second light borne information L2 which second light borne information L2 is arranged to be superposed to the first light borne information L1 such that the operator may see surrounding and supplementary information in the view opening 106.

By beam splitter below is intended a semi transparent element arranged to partly allow light to pass through and partly reflect light. The beam splitter according to a variant consists of a semi transparent mirror element and according to another variant of semi transparent prism element. A beam splitter is arranged to divide light into two or more parts.

FIG. 1 schematically illustrates a side view of a periscope device I according to a first embodiment of the present invention.

The periscope device I according to the first embodiment comprises a periscope body 100 and first and second redirecting surfaces 110, 120 according to above, the first and second redirecting surface 110, 120 constituting the surface of a mirroring element such as the surface of a mirror element or a prism element, i.e. reflection surfaces.

According to the first embodiment the projector P is arranged in connection to the lower portion 100b of the periscope body 100. The projector P is consequently according to this embodiment intended to be arranged in the inner area when the periscope device I is arranged on a vessel such as a vehicle.

The periscope device I comprises a third redirecting surface 130, which according to this embodiment is constituted by the surface of mirroring elements such as the surface of a mirror element or the surface of a prism element. The periscope device further comprises a projection surface 160 arranged to receive the light borne information L2 projected from the projector P, wherein the projector P is arranged such that the second light borne information L2 representing visual supplementary information is reflected towards the third redirecting surface 130 in the direction towards the projection surface 160. The projector P is consequently arranged to project the visual supplementary information towards the projection surface 160, wherein the visual supplementary information is created in the form of an image on the projection surface 160.

The periscope device I further comprises a fourth redirecting surface 140, which according to an embodiment is constituted by the surface of a mirroring element such as the surface of a mirror element or a prism element. The projection surface 160 is arranged to redirect the visual supplementary information/image L2 in the direction towards the fourth redirecting surface 140, where the redirection occurs by the projection surface 160 reflecting the second light borne information L2.

The periscope device I further comprises a fifth redirecting surface 150 which is constituted by the surface of a beam splitter 150. The fourth redirecting surface 140 is arranged to redirect the second light borne information L2 represented by visual supplementary information/image L2 projected on the projection surface in the direction towards the beam splitter 150.

According to this embodiment the periscope device I also comprises a lens element 170 arranged to form/modify the second light borne information L2 representing visual supplementary information redirected from the projection surface 160 such that the focal plane where the operator sees the visual supplementary information/virtual image lies closer to or further away. The lens element 170 is preferred but not necessary for the function.

The beam splitter 150 is arranged relative to the second redirecting surface and the fourth redirecting surface 140 such that it receives the first light borne information L1 from the second redirecting surface 120 and the second light borne information L2 from the fourth redirecting surface 140, wherein the beam splitter 150 is arranged to redirect the first light borne information L1 and the second light borne information L2 superposed in the direction towards the outlet opening 106 such that a user sees a superposed image of surrounding and supplementary information.

By providing the transmission of the periscope device I of the surrounding to a view opening 106 in accordance with a conventional periscope, i.e. by redirecting the first light borne information L1 by means of a first and a second redirecting surface 110, 120 constituting the surface of mirroring elements such as the surface of mirror elements or prism elements, the projector P, beam splitter 150 and remaining redirecting surfaces 130, 140 may be arranged on a conventional/existing periscope and thus provide superposition of surrounding and supplementary information by means of projector P, which among others has the advantage that existing periscopes may be upgraded, which may reduce costs and arrangement of the periscope device I according to the first embodiment on a vessel.

The advantage with arranging projector P and beam splitter and redirecting surfaces for redirection of the second light borne information L2 in connection to the lower portion 100b of the periscope body 100 is that they are arranged inside the vessel/vehicle and thus are protected by the vessel/vehicle.

FIG. 2 schematically illustrates a side view of a periscope device II according to a second embodiment of the present invention.

The periscope device II according to the second embodiment comprises a periscope body and first and second redirection surfaces 110, 120 according to above, the first and second redirecting surface 110, 120 constituting the surface of a mirroring element such as the surface of a mirror element or a prism element.

According to a second embodiment the projector P is arranged in connection to the upper portion 10a of the periscope body 100. The projector P is consequently according to this embodiment intended to be arranged in the upper area when the periscope device II is arranged on a vessel such as a vehicle.

The periscope device II comprises a third redirecting surface, which according to an embodiment is constituted by the surface of mirroring elements such as the surface of a mirror element or the surface of a prism element. The periscope device II further comprises a projection surface 160 arranged to receive and show the second light borne information L2 projected from the projector P, wherein the projector P is arranged such that the second light borne information L2 representing visual supplementary information is reflected towards the third redirecting surface in direction towards the projection surface 160.

The periscope device II further comprises a fourth redirecting surface 140, which according to an embodiment is constituted by the surface of a mirroring element such as the surface of a mirror element or prism element. The projection surface 160 is arranged to redirect the visual supplementary information/image L2 in the direction towards the fourth redirecting surface, where the redirection occurs by the projection surface 160 reflecting the second light borne information L2.

The periscope device II further comprises a fifth redirecting surface 150, which is constituted by the surface of a beam splitter 150. The fourth redirecting surface 140 is arranged to redirect the second light borne information L2 represented by visual supplementary information projected on the projection surface in the direction towards the beam splitter 150.

According to this embodiment the periscope device II also comprises a lens element 170 arranged to form/modify the light borne information L2 representing visual supplementary information redirected from the projection surface 160 such that the focal plane where the operator sees the visual supplementary information/ virtual image lies closer or further away. The lens element 170 is preferred but not necessary for the function.

The beam splitter 150 is arranged relative to the first redirecting surface 110 and the fourth redirecting surface 140 such that it receives the first light borne information L1 from the surrounding and the second light borne information L2 from the fourth redirecting surface 140, wherein the beam splitter 150 is arranged to redirect the first light borne information L1 and the second light borne information L2 superposed in the direction towards the first redirecting surface 110. The light being constituted by the first light borne information L1 and the second light borne information L2 superposed is arranged to be redirected by the first redirecting surface 110 in the direction towards the second redirecting surface 120, which in turn is arranged to redirect the superposed second light borne information L2 in the direction towards the outlet opening 106 such that a user sees a superposed image of surrounding and supplementary information.

By providing the transmission in the periscope device of the first light borne information representing surrounding to a view opening in accordance with a conventional periscope, i.e. by redirecting the first light borne information L1 by means of first and second redirecting surfaces 110, 120 constituting the surface of a mirroring element such as the surface of a mirror element or prism element, projector, beam splitter and remaining redirecting surfaces may be arranged in a conventional/ existing periscope and thus provide superposition of first light borne information representing surrounding and visual supplementary information by means of a projector P, which among others has the advantage that existing periscopes may be upgraded, which may reduce costs and arrangement on a vessel of the periscope device II according to the invention.

By arranging projector P and beam splitter 160 and redirecting surfaces for redirection of the second light borne information L2 in connection to the upper portion 100a of the periscope device 100 they are arranged outside of the vessel/vehicle which may be advantageous if there is lack of space inside the vehicle. Such a solution may be made compact and does not require adaptation to surrounding space. Projector P, beam splitter 160 etc. may according to a variant be built in under a shell in order to protect these components.

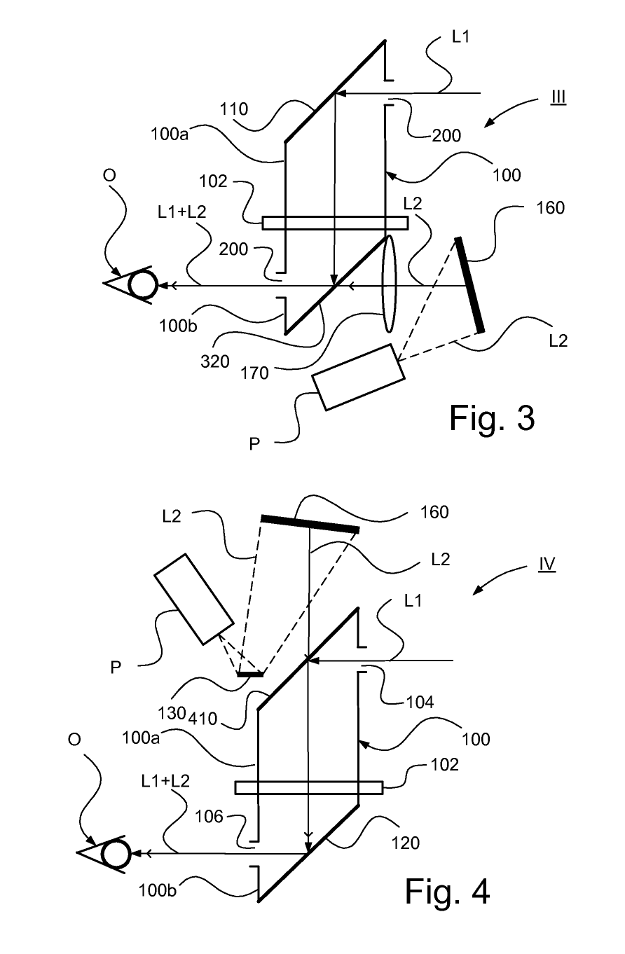

FIG. 3 schematically illustrates a side view of a periscope device III according to a third embodiment of the present invention. The periscope device III according to the third embodiment comprises a periscope body and first and second redirecting surfaces according to above, the second redirecting surface 320 being constituted by a beam splitter 320.

According to the third embodiment the projector P is arranged in connection to the lower portion 100b of the periscope body 100. The projector P is according to this embodiment consequently intended to be arranged in the inner area when the periscope device III is arranged on a vessel such as a vehicle.

The periscope device III comprises a projection surface 160 arranged to receive the light borne information L2 projected from the projector P, wherein the projector P is arranged such that the second light borne information L2 representing visual supplementary information is directed towards the projection surface 160. The projector P is consequently arranged to project the visual supplementary information towards the projection surface 160, wherein the visual supplementary information is created in the shape of an image on the projection surface 160.

The second redirecting surface 320 is according to this embodiment constituted by a beam splitter 320. The projection surface 160 is arranged to redirect the visual supplementary information L2 projected towards the projection surface 160 in the direction towards the second redirecting surface 320, i.e. towards the beam splitter 320, where the redirection occurs by the projection surface 160 reflecting the second light borne information L2 representing visual supplementary information.

According to this embodiment the periscope device III also comprises a lens element 170 arranged to modify/form the second light borne information L2 representing visual supplementary information redirected from the projection surface 160 such that the focal plane where the operator sees the visual supplementary information /virtual image lies closer to or further away. The lens element 170 is preferred but not necessary for the function.

The beam splitter 320 is arranged relative to the first redirecting surface 110 and the projection surface 160 such that it receives the first light borne information L1 from the first redirecting surface 110 and the second light borne information L2, i.e. visual supplementary information, from the projection surface 160, wherein the beam splitter 320 is arranged to redirect the first light borne information L1 and the second light borne information L2 superposed in the direction towards the outlet opening 106 such that a user sees a superposed image of surrounding and supplementary information.

As the second redirecting surface 320 here is constituted by a beam splitter 320, i.e. has a semi transparent surface, a simpler device is obtained wherein fewer redirecting surfaces, i.e. fewer mirror elements/prism elements, are required for providing of superposition of first light borne information L1 and second light borne information L2, i.e. the image representing supplementary information in the periscope body 100 of the periscope device III, which provides a simpler construction which may be made more compact.

FIG. 4 schematically illustrates a side view of a periscope device IV according to a fourth embodiment of the present invention.

The periscope device IV according to the fourth embodiment comprises a periscope body 100 and first and second redirecting surfaces 410, 120 according to above, the first redirecting surface 410 being constituted by a beam splitter 410.

According to the forth embodiment the projector O is arranged in connection to the upper portion 100a of the periscope body 100. The projector P is according to this embodiment consequently intended to be arranged in the outer area when the periscope device IV is arranged on a vessel such as a vehicle.

The periscope device IV comprises a third redirecting surface 130, which according to an embodiment is constituted by the surface of a mirroring element such as the surface of a mirror element or the surface of a prism element. The periscope device IV further comprises a projection surface 160 arranged to receive the second light borne information L2 projected from the projector P, wherein the projector P is arranged such that the second light borne information L2 representing visual supplementary information/image is reflected towards the third redirecting surface 130 in the direction towards the projection surface 160. The projector P is consequently arranged to project the visual supplementary information towards the projection surface 160, wherein the visual supplementary information is created in the shape of an image on the projection surface 160. The third redirecting surface 130 is arranged such that the projector P may be arranged in the sealing of a vessel, which has the advantage that the projector P does not take up unnecessary space and risks being in the way. Alternatively the third redirecting surface 130 could be spared, wherein the projector has to be arranged and directed in another way, i.e. towards the projection surface 160.

The first redirecting surface 410 is according to this embodiment constituted by a beam splitter 410. The projection surface 160 is arranged to redirect the second light borne information L2 representing visual supplementary information projected towards the projection surface 160 in the direction towards the first redirecting surface 410, i.e. towards the beam splitter 410, the redirection occurring by the projection surface 160 reflecting the second light borne information L2.

According to this embodiment the periscope device IV does not comprise any lens element arranged to focus the second light borne information L2 representing visual supplementary information redirected from the projection surface 160, but according to an alternative variant a lens element could be arranged to modify/form the second light borne information L2 representing visual supplementary information redirected from the projection surface 160 such that the focal plane where the operator sees the visual supplementary information/virtual image lies closer or further away.

The beam splitter 410 is arranged relative to the inlet opening 104 and the projection surface 160 such that it receives the first light borne information L1 from the surrounding and the second light borne information L2 representing visual supplementary information from the projection surface 160, wherein the beam splitter 410 is arranged to redirect the first light borne information L1 and the second light borne information L2 superposed in the direction towards the second redirecting surface 120, wherein the second redirecting surface 120 is arranged to redirect the superposed beam in the direction towards the outlet opening 106 such that a user sees a superposed image of surrounding and supplementary information.

As the first redirecting surface 410 here is constituted by a beam splitter 410, i.e. has a semi transparent surface, a simpler device is obtained wherein fewer redirecting surfaces, i.e. fewer mirroring elements such as mirror element/prism element, are required for providing of superposition of first light borne information and second light borne information. Hereby the second light borne information L2, i.e. the image representing supplementary information in the periscope body 100 of the periscope device IV, which provides a simpler construction which may be made more compact.

By arranging projector P and beam splitter 410 and third redirecting surface 130 for redirecting of the first light borne information L2 in connection to the upper portion 100a of the periscope device 100 arranged outside the vessel/vehicle which may be advantageous if there is lack of space inside the vehicle. Such a solution may be made compact and does not require adaptation to surrounding space. Projector, beam splitter etc. may according to a variant be built in under a shell in order to protect these components.

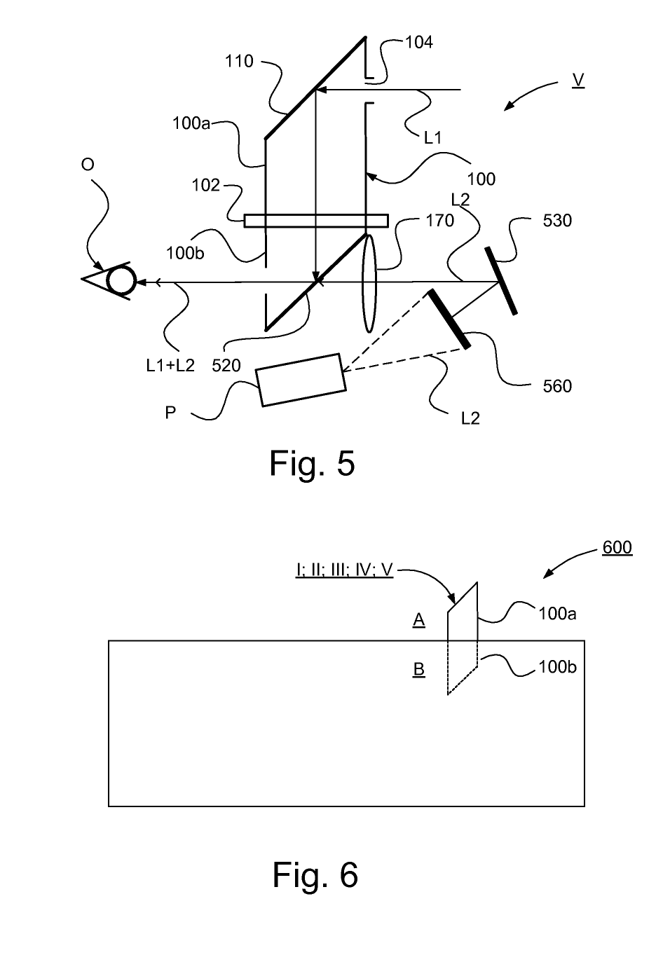

FIG. 5 schematically illustrates a side view of a periscope device V according to a fifth embodiment of the present invention.

The periscope device V according to the fifth embodiment comprises a periscope body and first and second redirecting surfaces 110, 520 according to above, where the second redirecting surface 520 is constituted by a beam splitter 520.

According to the fifth embodiment the projector P is arranged in connection to the lower portion 100b of the periscope body 100. The projector P is according to this embodiment consequently intended to be arranged in the inner area when the periscope device V is arranged on a vessel such as a vehicle.

The periscope device V comprises a projection surface 560 arranged to receive the second light borne information L2 projected from the projector P, wherein the projector P is arranged such that the second light borne information L2 representing visual supplementary information is directed towards the projection surface 560. The projector P is consequently arranged to project the visual supplementary information towards the projection surface 560, wherein the visual supplementary information is created in the shape of an image on the projection surface 560.

The periscope device V comprises a third redirecting surface 530, which according to an embodiment is constituted by the surface of a mirroring element such as the surface of a mirror element or the surface of a prism element. The third redirecting surface is arranged relative to the projection surface 560 such that it receives the second light borne information L2 projected from the projection surface 560. The projection surface 560 is arranged to redirect the second light borne information projected towards the projection surface 560 in the direction towards the third redirecting surface 530. The projection surface 560 is according to this embodiment configured to allow the second light borne information L2 projected from the projector P through such that it is back-projected on the third redirecting surface 530. According to a variant this is provided by lighting up/projecting the second light borne information L2 towards the back side of a screen 560 allowing it through such that the image is thus created.

The third redirecting surface 530 is arranged to redirect the second light borne information L2 in the direction towards the second redirecting surface 520, the second redirecting surface 520 according to this embodiment being constituted by a beam splitter 520.

According to this embodiment the periscope device V also comprises a lens element 170 arranged to form/modify the second light borne information redirected from the third redirecting surface 530 such that the focal plane where the operator sees the visual supplementary information/virtual image lies closer or further away. The lens element 170 is preferred but not necessary for the function.

The beam splitter 520 is arranged relative to the first redirecting surface 110 and the third redirecting surface 530 such that it receives the first light borne information L1 from the first redirecting surface and the second light borne information L2 from the third redirecting surface 530, wherein the beam splitter 520 is arranged to redirect the first light borne information L1 and the second light borne information L2 superposed in a direction towards the outlet opening 106 such that an operator 0 sees a superposed image of the surrounding and supplementary information.

As the second redirecting surface 520 here is constituted by a beam splitter 520, i.e. has a semitransparent surface, a simpler device is obtained wherein fewer redirecting surfaces, i.e. fewer mirror elements/prism elements, are required for providing of superposition of first light borne information and second light borne information L2. Hereby the second light borne information L2, i.e. the image representing supplementary information is received into the periscope body 100 of the periscope device V, which results in a simpler construction which may be made more compact.

The periscope device V according to the fifth embodiment in FIG. 5 thus shows projection of an image by so called back projection where the projection surface/screen 560 allows the second light borne information L2 through. Also the embodiments according to FIG. 1-4 would function with the back projection according to the embodiment in FIG. 5.

The periscope device I; II; III; IV; V according to the embodiments in FIG. 1-5 comprises a projector P arranged to project supplementary information in the form of second light borne information L2 which second light borne information is arranged to be superposed on the first light borne information L1 such that the operator O may see surrounding and supplementary information in the view opening 106.

With projector is above intended an apparatus for visually representing images/image information by illuminating a diffusively reflecting or transmitting projection surface.

The projector P is constituted by one or more light sources being reflected or transmitted towards one or more image elements. The image elements affect the light such that the light after the image element contains the image information. The light then passes optics, the object of which is to provide focus of image and desired size of image at the projection surface. At the projection surface the light is arranged to be reflected diffusively, so called front projection, or transmitted diffusively, so called back projection. The diffuse reflection/transmission results in the image being viewable from several angles.

The light source in the projector P is according to an embodiment constituted by one or more light-emitting diodes. This results in the projector P not being sensitive to shakes and bumps but is relatively insensitive and durable.

And advantage with using a projector for projection of supplementary information is that a light intense image source is obtained which facilitates use in normal to strong light conditions. The superposed image may thus be made brighter which e.g. may be used if a symbol illustrating an alarm is to be shown superposed. The level of brightness may further be controlled by means of the projector P by changing the level of brightness on the light source. Further, projector facilitates easy change of image size an image shape by changing/vary the distance projector projection surface and/or adjusting optics and/or shape on the projection surface, in order to easily adjust image quality and placement of periscope.

By using a projector easy correction of distortions in the image from the second light borne information representing supplementary information with an adapted projection surface and to move the image in the periscope such that it ends up on desired position is facilitated.

The projector P receives its information from e.g. a PC, camera, another sensor or the corresponding.

Above a periscope device I; II; III; IV; V according to a first, second, third, fourth and fifth embodiment of the present invention has been described, wherein the first light borne information L1 at the view opening 106 is arranged to be superposed with the visual supplementary information represented by the second light borne information L2 provided from the projector P.

According to an alternative embodiment the visual supplementary information at the view opening represented by the second light borne information L2 may in the periscope device I; II; III; IV; V according to the first, second, third, fourth and fifth embodiment of the present invention be arranged to be presented separated from the first light borne information. The projection surface 160; 560 towards which the projector P is arranged to project the second light borne information L2 such that the visual supplementary information is created in the form of an image on the projection surface, wherein the projection surface 160; 560 is arranged to redirect the visual supplementary information for said separated presentation, i.e. the projection surface is arranged such that the visual supplementary information created on the projection surface is shown separated from the surrounding in the view opening. Thus the projection surface may be arranged such that an operator looking in the view opening in an angle where the surrounding can not be seen, sees the visual supplementary information in that angle.

According to an additional alternative embodiment the periscope device I; II; III; IV; V according to the first, second, third, fourth and fifth embodiment of the present invention may the first light borne information L1 at the view opening be arranged to at least partly be superposed with the second light borne information L2 representing the visual supplementary information. According to a variant the projection surface 160; 560 towards which the projector P is arranged to project the second light borne information L2 such that the visual supplementary information is created in the form of an image on the projection surface, wherein the projection surface 160; 560 is arranged to redirect the visual supplementary information for said partly superposed presentation, i.e. the projection surface is arranged such that the supplementary information created on the projection surface is shown partly superposed to the surrounding in the view opening.

Consequently, in the periscope device for transmission of surrounding represented by a first light borne information L1 to the view opening 106 according to the present invention, the first light borne information L1 at the view opening is arranged to be presented together with visual supplementary information L2 represented by a second light borne information L2, the presentation of the second light borne information L2 occurring superposed, partly superposed or separated from the first light borne information L1.

FIG. 6 schematically illustrates a vessel 600 with a periscope device I; II; III; IV; V according to any of the first, second, third, fourth or fifth embodiment of the present invention.

The periscope device has an upper portion 100a arranged externally to the vessel on a surrounding side A and an inner portion 100b arranged internally to the vessel on a vessel interior side B.

The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated.

1. A periscope device for transmission of a surrounding represented by first light borne information to the view opening, wherein the first light borne information at the view opening is arranged to be presented together with visual supplementary information represented by second light borne information, characterized in that the visual supplementary information is arranged to be provided by means of a projector.

2. A periscope device according to claim 1, wherein the first light borne information at the view opening is arranged to at least partly be superposed with the second light borne information representing the visual supplementary information.

3. A periscope device according to claim 1, wherein the visual supplementary information at the view opening represented by the second light borne information is arranged to be presented separated from the first light borne information.

4. A periscope device according to claim 1, wherein said presentation of the first and second light borne information is arranged to be provided by means of a beam splitter, arranged to reflectively redirect one of the first and second light borne information, and transmittingly redirect another of the first and second light borne information.

5. A periscope device according to claim 1, comprising a projection surface towards which the projector is arranged to project the second light borne information representing the visual supplementary information which is created in the shape of an image on the projection surface, wherein the projection surface is arranged to redirect the visual supplementary information for said presentation.

6. A periscope device according to claim 5, wherein the projection surface is arranged to be diffusively reflectively redirect the second light borne information representing the visual supplementary information.

7. A periscope device according to claim 5, wherein the projection surface through back projection is arranged to diffusively transmittingly redirect the second light borne information representing the visual supplementary information.

8. A periscope device according to claim 1, comprising a light proof periscope body with an upper portion intended to be arranged externally to a vessel, and a lower portion intended to be arranged inside the vessel, wherein the first light borne information is arranged to be transmitted via an opening in the upper portion to the view opening being arranged in the lower portion.

9. A periscope device according to claim 8, comprising a first redirecting surface arranged in the upper portion of the periscope body and a second redirecting surface arranged in the lower portion of the periscope body, wherein the first redirecting surface is arranged to redirect the first light borne information in a direction towards the second redirecting surface, wherein the second redirecting surface is arranged to redirect the first light borne information redirected from the first redirecting surface to the view opening.

10. A periscope device according to claim 8, wherein said projector is arranged in connection to the lower portion of the periscope body.

11. A periscope device according to claim 4, wherein the beam splitter is constituted by the second redirecting surface.

12. A periscope device according to claim 8, wherein said projector is arranged in connection to the upper portion of the periscope body.

13. A periscope device according to claim 9, wherein the beam splitter is constituted by the first redirecting surface.

14. A periscope device according to claim 7, wherein the first redirecting surface and the second redirecting surface is constituted by the surface of a mirroring element.

15. A periscope device according to claim 12, wherein the beam splitter is arranged relative to the first and second redirecting surface, wherein a redirecting surface is arranged to redirect the second light borne information redirected from the projection surface towards the beam splitter.

16. A periscope device according to claim 1, comprising a lens element arranged to modify the second light borne information prior to said presentation.

17. A vessel comprising a periscope device according to claim 1.
